(19) United States
(12) Patent Application Publication
(10) Pub. No.: US 2011/0284085 A1
(43) Pub. Date: Nov. 24, 2011

(54) VALVE AND METHOD FOR FLOW CONTROL

(75) Inventor: Göran Cewers, Limhamn (SE)

(73) Assignee: MINDRAY MEDICAL SWEDEN AB, SUNDBYBERG (SE)

(21) Appl. No.: 13/106,654

(22) Filed: May 12, 2011

Related U.S. Application Data
(60) Provisional application No. 61/345,628, filed on May 18, 2010.

(51) Int. Cl. F16K 31/00

(52) U.S. Cl. 137/1; 251/294

(57) ABSTRACT

The disclosure relates to a device for controlling the flow of a fluid through a flow channel. The flow is controlled by means of a flexible conduit with flexible circular segments compressed along the length of the conduit, whereupon the flexible elements collapse against a circular wall.

### CROSS-REFERENCE TO RELATED APPLICATION(S)

This application claims the benefit of U.S. Provisional Application No. 61/345,628, filed May 18, 2010, which is incorporated herein by reference.

### TECHNICAL FIELD

The following disclosure relates to valves, and more particularly, to a valve device for mechanically controlling the flow of at least one fluid through at least one channel.

### SUMMARY OF THE INVENTION

A valve may include at least two flexible elements, where each flexible element includes at least one flexible zone. At least one valve seat may correspond to at least one of the flexible elements positioned either outside and/or inside the at least two flexible elements in such a way that a fluid may pass through at least one channel between the flexible elements and the valve seats. The valve may also include at least one actuator unit, which is arranged to axially compress or decompress the at least two flexible elements, wherein at least one flexible element is substantially angled radially towards or straightened up from a valve seat and thereby may control a flow of at least one fluid through the valve channels.

### BRIEF DESCRIPTION OF THE DETAILS

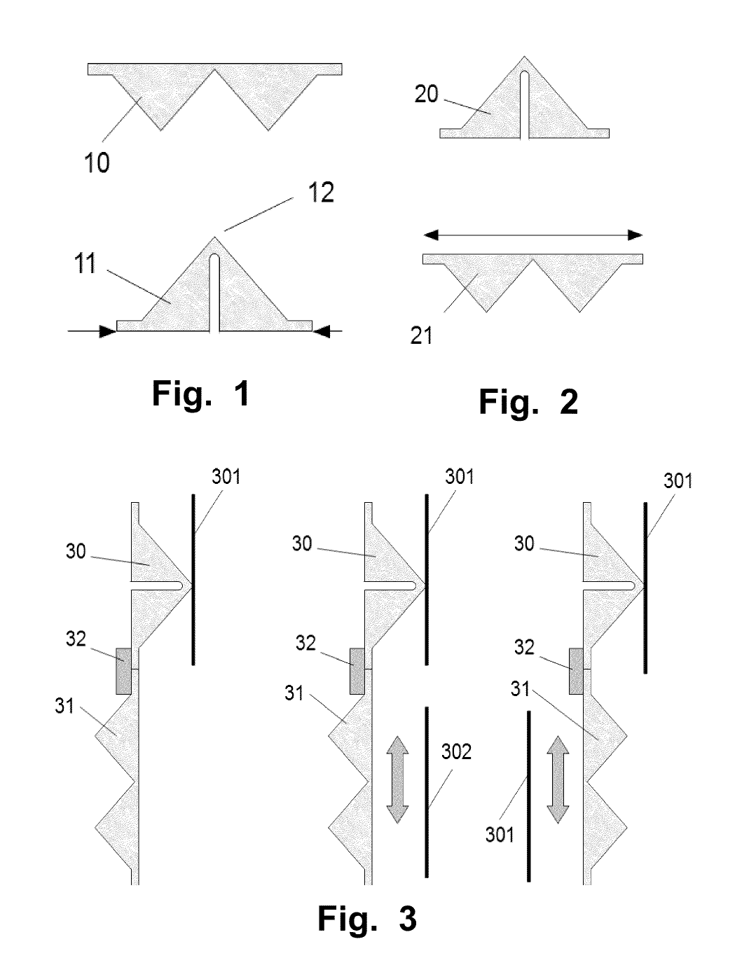

FIGS. 1 and 2 are schematic views showing a cross-section of an exemplary embodiment of a flexible conduit segment;

FIG. 3 is a schematic view showing exemplary embodiments of valve configurations;

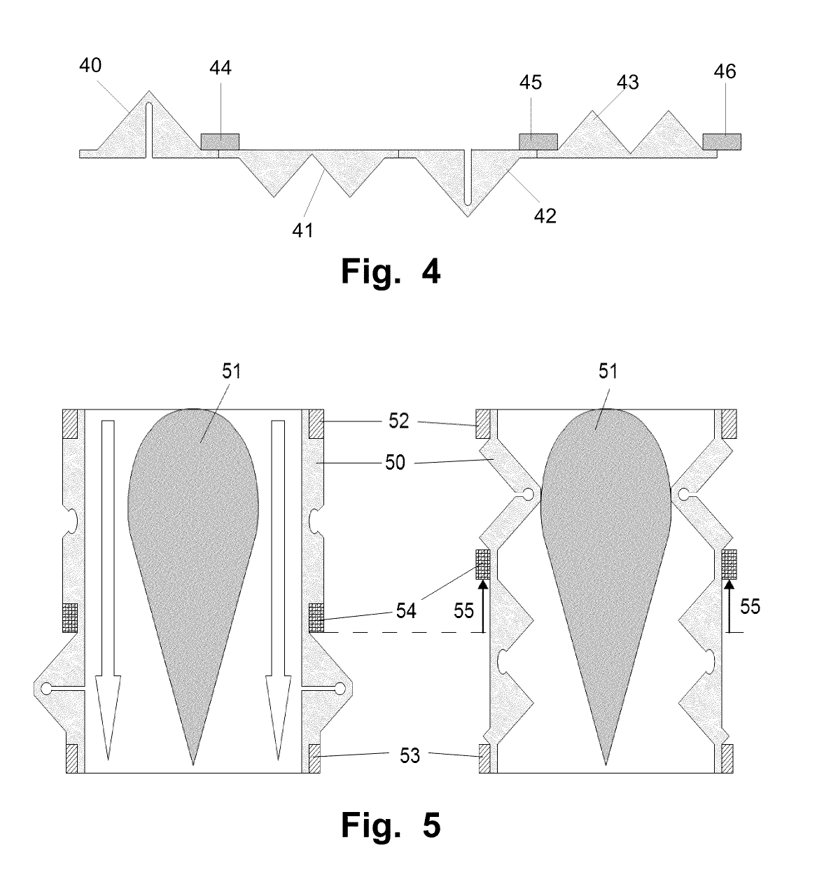

FIG. 4 is a schematic view showing an example of how the flexible tube segments may be combined;

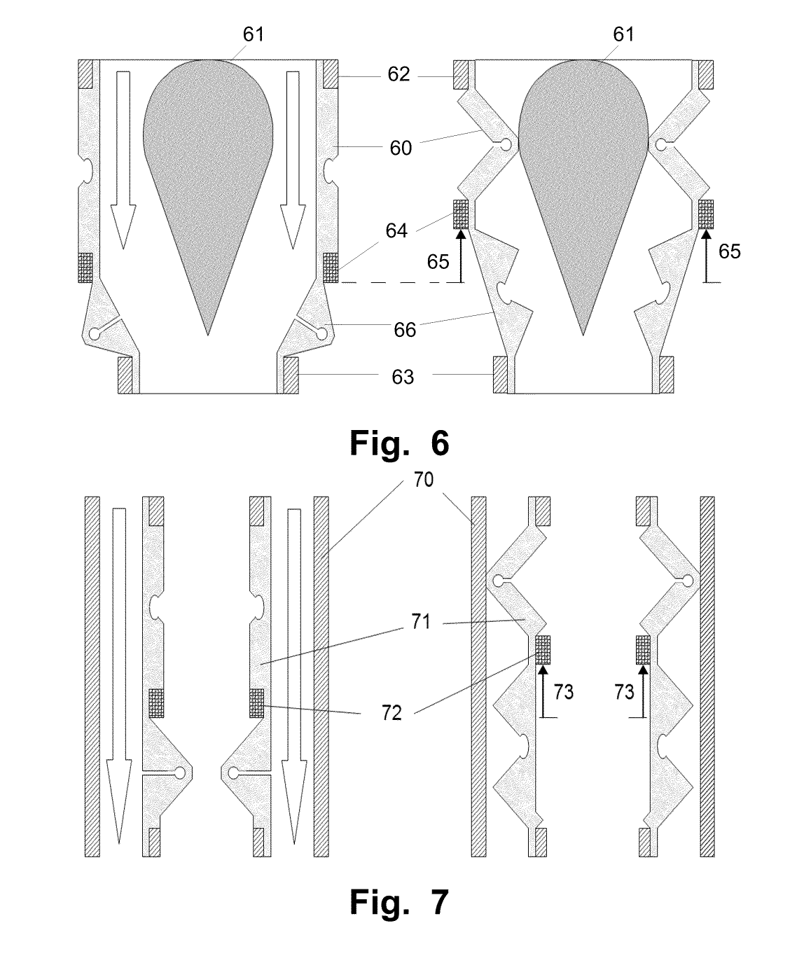

FIGS. 5 and 6 are schematic views showing an exemplary embodiment of a low pressure valve with a flexible conduit surrounding a rotationally symmetric body; and

FIG. 7 is a schematic view showing an exemplary embodiment of a low pressure valve with a surrounding hard conduit.

### DETAILED DESCRIPTION

When designing a low pressure valve, especially in the field of gas control in medical ventilators, the flow channel in the valve should have low flow resistance and no turbulence, and the valve should be easy to clean. Moreover, it is often desirable for the design to be small and light and that the actuator controlling the valve is small and isolated from the flow channel.

Examples of low pressure valve applications are expiration valves, patient pressure relief valves, mixer valves, and flow valves in low pressure systems.

Today, the most common design of low pressure valves comprises a circular disk lying against the end of a tube forming a valve seat, as illustrated in U.S. Pat. No. 5,127,400. The drawbacks of such a design are the complexity of the flow channel, which causes turbulence and cleaning issues. Moreover, the entire circular disk is exposed to pressure, while the flow only depends on the outer edge of the disk. Thus, an unnecessarily strong, heavy, and expensive actuator is needed to control this type of valve.

One aspect of the disclosure includes a valve comprising at least two flexible elements, where each flexible element includes at least one flexible zone. In some embodiments, at least one valve seat corresponds to at least one of the flexible elements positioned either outside and/or inside the at least two flexible elements in such a way that a fluid may pass through at least one channel between the flexible elements and the valve seats. The valve may also include at least one actuator unit, which is arranged to axially compress or decompress the at least two flexible elements, wherein at least one flexible element is substantially angled radially towards or straightened up from a valve seat and thereby may control a flow of at least one fluid through the valve channels.

In an embodiment where the flexible elements are in their normal position, the valve is open, and a flow of at least one fluid, which may be described as essentially without turbulence, may occur in the channel between the flexible elements and at least one valve seat. A flexible element of the present disclosure is provided as having one or more zones that are operable as articulations in order for the flexible element to be controllably angled or protruded radially towards a valve seat when the flexible element is exposed to an axial compressive or decompressive motion from an actuator unit. With increasing angulation of the flexible element, at least one area of the flexible element will touch the valve seat. In one embodiment, the touching area is the flexible zone, and the area or zone may be designed so that a tight sealing effect occurs between the angled flexible element and the valve seat.

The term “axial directed movement/motion” herein refers to a direction along or against the direction of flow, which takes place between two openings positioned at each side of a flow channel. The term “radial directed movement/motion” refers to movement substantially vertical to the direction of the flow.

In some embodiments, the flexible elements of the valve are configured so they, in at least one position, have a side having even characteristic located on the flow side of at least one channel.

This configuration allows for an essentially non-turbulent flow in (for the channel) the open position, which decreases the flow resistance of the fluids through the flow channel.

In some embodiments, the valve comprises at least two flexible elements and the first flexible element is arranged to control the flow while at least one other flexible element is positioned so as to allow the relative axial movement. As a result, deformation and wear of the first flexible element is avoided upon repeated folding.

To facilitate the positioning of the valve between two non-flexible in- and outlet channels, additional flexible elements may be utilized so that the axial compressing or decompressing movement of the choking flexible element (for the valve) can be carried out. Thus, strain on the material or on the mountings of the non-flexible in- and outlet channels is avoided.

In yet another embodiment, the valve comprises at least two flexible elements, where at least two flexible elements are arranged to control the flow in at least one channel, while at least one other flexible element is positioned to allow the relative axial movement to be performed. This embodiment has similar advantages as those mentioned above, but can also be used, e.g., for alternately controlling the flow through two channels and/or parts of a channel. In an embodiment of this kind, the first flexible element is used for opening and closing the first flow channel at the same time as the second flexible element is used for opening and closing, e.g., a second flow channel. They work together to facilitate the axial movement and thereby avoiding deformation and wear on both flexible elements. This design also has the advantage of the flow being controlled in both flow channels simultaneously. The flexible elements may, in this embodiment, use the same valve wall, but may also be provided in a configuration such that each flexible element that is controlling a flow has a separate valve wall. This embodiment may be extended to include, where necessary, more than two flexible elements and several flow channels.

In some embodiments, the valve seat is provided as a rotationally symmetric circular wall placed at the center of at least one of the flexible elements, such as the outside of a rod, or the inside or outside of a conduit. In some embodiments, the valve seat has a rotationally symmetric conical profile and is positioned at the center of at least one of the flexible elements downstream. The valves may also be designed with valve seats, including rotationally symmetric circular walls, which may include the inside of a conduit, placed around at least one of the elements.

In another embodiment, the construction material in the flexible elements of the valve and the valve seats is autoclavable and/or the construction material in the flexible elements and the valve seats are disposable, or the design may comprise parts being autoclavable combined with parts being disposable. Examples of such autoclavable materials include silicone rubber, stainless steel, etc. Choosing these materials allows the valves to be used in medical devices, such as a breathing apparatus. Valves contaminated by the patient can thus be safely cleaned and disinfected between different patients.

In some embodiments, the actuator unit of the valve is at least one piezoelectric actuator. In other embodiments, the actuator unit may comprise at least one coil actuator. A skilled artisan will recognize that other types of actuator units may be suitable.

Yet another advantage of the design is that actuator unit of the valve may be arranged without contact with the flow channel, and thus, the actuator need not be autoclavable. This simplifies handling and increases the lifetime of the actuator.

In some embodiments, the valve has an integrated flow meter. In particular, at least two ultrasound transceivers may be placed along at least one of the flow channels to measure the flow through the channel. This provides for a compact unit. Additionally, the unit allows rapid control of the flow through the valve, since the distance between the flow meter and the valve may be kept short, and turbulence can be avoided.

In another aspect, the disclosure includes a method for controlling a flow through at least one fluid passage, wherein the method comprises axially compressing or decompressing at least two flexible elements of a valve, wherein at least one flexible element is angled substantially towards or straightened up from a corresponding valve seat in order to control the flow. The valve may be designed as described above.

The advantages of this method are the same as for the equipment described above: a substantially non-turbulent flow of one or more fluids can be created through one or more flow channels, and the flow can easily be choked when needed. The flow control is rapid and reliable with a compact unit. Piezo actuators may be used, which provide for low energy consumption.

FIG. 1 is a schematic view showing the cross section of an exemplary embodiment of a flexible conduit segment, where 10 is shown in an unaffected condition, while 11 is in a compressed condition with a circular protrusion 12 acting as a soft valve element. In this state, is the valve device is normally open (“NO”).

FIG. 2 is a schematic view showing the cross section of an exemplary embodiment of a flexible conduit segment. In this embodiment, 20 being in the unaffected state, while 21 is in the expanded state.

FIG. 3 is a schematic view showing some exemplary valve configuration designs. In this embodiment, 301 is the inside or outside of a hard conduit, 30 and 31 are flexible conduit segments, and 32 is a hard ring whose axial movement controls the valve device. A second hard conduit 302 or 301 forms a second valve function of the valve device.

FIG. 4 is a schematic view showing an example of how the flexible conduit segments of the same flexible conduit may be combined in a plurality of ways to obtain various valve functions. In this embodiment, 40 and 42 show compressed flexible elements, and 41 and 43 show decompressed elements. As illustrated, 44, 45 and 46 are surrounding fastening rings, which can either be stationary or may be pushed a distance using the actuator unit and thereby compressing or decompressing adjacent flexible elements.

FIG. 5 is a schematic view showing an exemplary embodiment of a low pressure valve with a flexible conduit surrounding a rotationally symmetric body 51. The right drawing illustrates how the flexible conduit segment 50 collapses and is pressed towards the rotationally symmetric body 51 so that the valve device becomes closed when the circular ring 54 is moved a distance 55 from the fastening ring 53 and towards fastening ring 52.

FIG. 6 is a schematic view showing an exemplary embodiment of a variant of the low pressure valve according to FIG. 5. In this exemplary embodiment, a low pressure valve has a flexible conduit surrounding a rotationally symmetric body 61. The right figure illustrates how the flexible conduit segment 60 collapses and is pressed towards the rotationally symmetrical body 61, so that the valve device becomes closed when the circular ring 64 is moved a distance 65 from the fastening ring 63 and towards fastening ring 62. In this exemplary embodiment, the lower part of the flexible conduit, the flexible element 66, has been shaped as a cone to optimize the flow channel for further connection to, e.g., a tube. This design has also the advantage of decreasing the turbulence of the flow due to the conical shape.

FIG. 7 is a schematic view showing an exemplary embodiment of a low pressure valve with a hard conduit 70 surrounding a flexible conduit 71. When ring 72 is moved the distance 73, the valve device is closed.

A device according to one embodiment of the disclosure may be obtained by means of a soft conduit, fastened at the ends, and manufactured of, e.g., silicone rubber, with flexible segments, as shown in FIG. 1 or 2. In one embodiment, via a movable ring, the flexible conduit is exposed to an axial movement between the ends so that the flexible elements are affected. FIG. 5 illustrates one such example. The figure shows the same valve device in two different states. The left illustration shows the valve device in the open state and the right in the closed state.

A rotationally symmetrical hard body 51 may be centered inside the flexible conduit, which has been aerodynamically designed to minimize the flow resistance in the valve device. Body 51 is fastened to the fastening rings 52, 53 by supporting elements (not shown). When the valve device is in the open state, as shown in the left illustration of FIG. 5, the inside of the flexible conduit is virtually completely straight and even. This, in combination with the design of the center body 51, results in very low flow resistance. The valve device is closed by moving ring 54 the distance 55 in a direction towards fastening ring 52 so that the flexible conduit segment 50 is pressed against the body 51. In this position, the flow profile is no longer at optimum. However, this is not significant, as there is no flow passing through the valve device in the closed position.

The ring may also be positioned between the closed and open position. In this case, the valve device acts as a proportional valve. The flexible conduit segment 50 has been made lighter by removing material from the outside to reduce outer dimensions and to improve response times of the system. The device will also function with a flexible conduit segment, according to FIG. 1. The response time may also be improved by removing material from the lower flexible conduit segment in FIG. 5.

As mentioned, various types of valves may be provided using the principles of the disclosure, e.g., expiratory valves, patient pressure relief valves, mixer valves, and flow valves in low pressure systems, two way valves, and multipath selector valves.

Without further elaboration, it is believed that one skilled in the art can use the preceding description to utilize the present disclosure to its fullest extent. The examples and embodiments disclosed herein are to be construed as merely illustrative and not a limitation of the scope of the present disclosure in any way. It will be apparent to those having skill in the art that changes may be made to the details of the above-described embodiments without departing from the underlying principles of the disclosure described herein. In other words, various modifications and improvements of the embodiments specifically disclosed in the description above are within the scope of the appended claims. The scope of the invention is, therefore, defined by the following claims. The words “including” and “having,” as used herein, including in the claims, shall have the same meaning as the word “comprising.”

What is claimed is:

1. A valve comprising:
at least two flexible elements, wherein each flexible element has at least one flexible zone;
at least one valve seat corresponding to at least one of said flexible elements, the at least one valve seat positioned either outside and/or inside of said at least two flexible elements in such a way that a fluid can pass through at least one channel obtained between said flexible elements and said valve seat for passage of a fluid;
at least one actuator unit arranged to axially compress or decompress said at least two flexible elements, wherein at least one of said flexible elements is angled substantially radially towards or straightened up from a valve seat, such that a flow of at least one fluid through said channels of said valve is controllable.

2. The valve according to claim 1, wherein each flexible element has at least one flexible zone being an articulation arranged to angle said flexible elements substantially radially.

3. The valve according to claim 1, wherein an area of said at least one flexible element has a touching area configured to, after said first flexible element is angled radially a defined distance, touch a valve seat with said touching area.

4. The valve according to claim 3, wherein said touching area includes said flexible zone.

5. The valve according to claim 1, wherein said at least one flexible element has a zone configured to provide a sealing effect occurs when it touches said valve seat.

6. The valve according to claim 1, wherein said flexible elements and said valve seats are arranged and positioned relative each other so that said flexible elements are arranged in at least one position that allows a flow being substantially without turbulence through at least one flow channel of said valve.

7. The valve according to claim 1, wherein said flexible elements are configured, in at least one position, to have a side with even characteristic located on at least one flow side of said channel.

8. The valve according to claim 1, further comprising at least two flexible elements, and wherein said first flexible element is arranged to control said flow while said at least one second flexible element is located to allow said relative axial movement.

9. The valve according to claim 1, further comprising at least two flexible elements; wherein the at least two flexible elements are arranged to control said flow in at least one channel while the other flexible elements are positioned to allow said relative axial movement to be performed.

10. The valve according to claim 1, wherein said axial motion is along or against a direction of said flow.

11. The valve according to claim 1, wherein said radial motion occurs substantially vertical relative a direction of said flow.

12. The valve according to claim 1, wherein said valve seat is a rotationally symmetric circular wall located in the center of said flexible elements.

13. The valve according to claim 1, wherein said valve seat has a rotationally symmetric conical profile and is located in the center of said flexible elements downstream.

14. The valve according to claim 1, wherein said valve seat is a rotationally symmetric circular wall placed around at least one of said flexible elements.

15. The valve according to claim 1, wherein said valve seat is a rotationally symmetric circular wall comprising the inside of a conduit.

16. The valve according to claim 1, wherein a construction material of said flexible elements and said valve seat is autoclavable.

17. The valve according to claim 1, wherein a construction material of said flexible elements and said valve seat is disposable.

18. The valve according to claim 1, wherein said actuator unit is at least one piezoelectric actuator.

19. The valve according to claim 1, wherein said actuator unit is arranged without contact to the flow channel.

20. The valve according to claim 1, wherein at least two ultrasound transceivers are located along at least one flow channel to measure said flow through said channel.

21. The valve according to claim 1, wherein at least one flexible element becomes compressed while at least one flexible element becomes expanded.

22. A method for controlling a flow through at least one fluid passage, wherein the method comprises, using at least one actuator unit, axially compressing or decompressing at least two flexible elements of a valve, wherein said at least one of said flexible elements is angled substantially radially towards or straightening up from a corresponding valve seat for controlling said flow.

23. The method of claim 22, wherein at least one flexible element is compressed while at least one flexible element is expanded.
